(19) United States
(12) Patent Application Publication
(10) Pub. No.: US 2016/0098664 A1
(43) Pub. Date: Apr. 7, 2016

(54) Workforce Management System

(71) Applicant: ADP, LLC, Roseland, NJ (US)

(72) Inventors: Zahide Ahu Yildirmaz, Warren, NJ (US); Mita Goldar, Somerset, NJ (US); Sofia Maria Koropeckyj, Jenkintown, PA (US); Weijia Chen, West Chester, PA (US); Ying Sun, Malvern, PA (US)

(21) Appl. No.: 14/507,340

(22) Filed: Oct. 6, 2014

(51) Int. Cl. G06Q 10/06; G06Q 40/00

(52) U.S. Cl. CPC G06Q 10/06398; G06Q 40/125

(57) ABSTRACT

A method and apparatus for identifying a vitality for a workforce is presented. Groups of people in the workforce are selected based on a number of characteristics about the groups. A model for the vitality for the groups of people is generated by a computer system from payroll data for the groups. The model shows the vitality for the groups of people as a measure of performance for the groups based on the payroll data. Proportions of the payroll data for the groups of people in the payroll data are identified by the computer system. The model is adjusted by the computer system based on a difference between the proportions of the payroll data and desired proportions of the payroll data for the groups of people in the payroll data. The model has a desired level of accuracy and enables changing the workforce based on an analysis using the model.

### BACKGROUND INFORMATION

1. Field

The present disclosure relates generally to data processing systems and, in particular, to processing and analyzing the vitality of a workforce. Still more particularly, the present disclosure relates to a method, system, and computer program product for identifying changes to the workforce from an analysis of the vitality of the workforce.

2. Background

A workforce is people engaged in or available to perform work. A person is part of the workforce when the person is currently employed. The person also may be considered to be part of the workforce when the person is unemployed but actively seeking employment.

Employers may seek to manage various aspects of an organization. For example, an employer may seek to increase the profitability, environmental friendliness, efficiency, or other factors involved in operating an organization.

One manner in which the employer manages the organization is by performing different recruiting, hiring, retention, and management operations with respect to the employees in the organization. These and other operations may be part of workforce planning. Workforce planning is a process used to align the needs and priorities of the organization with those of its workforce to meet various objectives. One manner in which this type of planning may be performed involves analyzing the workforce. The workforce may include employees other than those in the organization.

The analysis may involve using software applications to perform various statistical, predictive, and other types of analyses of the workforce. With the analysis of the workforce, the employer also may be able to predict the probability of success of an employee, identify when new departments or positions are needed, determine when positions may be reassigned or eliminated, identify changes in the work environment to increase job satisfaction, identify changes in the work environment to increase safety, determine when to purchase assets, optimize the organizational structure, and other suitable changes.

The vitality of the workforce is a measure of the performance of the workforce. This measure of performance may be described as, for example, the productivity of the employees in the workforce and the emotional commitment the employees have to employers and employer goals.

Identifying where the vitality of the workforce needs to be improved is a time-consuming and error-prone process.

As a result, the amount of time and effort required for identifying where the vitality of the workforce needs to be improved may not be as fast or as accurate as desired. As a result, workforce planning and performing actions to manage the workforce may be more difficult than desired.

Therefore, it would be desirable to have a method and apparatus that take into account at least some of the issues discussed above, as well as other possible issues. For example, it would be desirable to have a method and apparatus that identify the vitality of the workforce with a desired level of accuracy that enables workforce planning.

### SUMMARY

In one illustrative embodiment, a method for identifying a vitality for a workforce is presented. Groups of people in the workforce are selected based on a number of characteristics about the groups of people. A model for the vitality for the groups of people is generated by a computer system from payroll data for the groups of people. The model shows the vitality for the groups of people as a measure of performance for the groups of people based on the payroll data. Proportions of the payroll data for the groups of people in the payroll data are identified by the computer system. The proportions of the payroll data for the groups of people are proportions of sets of the payroll data defined by the number of characteristics about the groups of people. The model is adjusted by the computer based on a difference between the proportions of the payroll data and desired proportions of the payroll data for the groups of people in the payroll data. The model has a desired level of accuracy and enables changing the workforce based on an analysis using the model.

In another illustrative embodiment, a workforce vitality system comprises a workforce analyzer that selects groups of people in a workforce based on a number of characteristics about the groups of people. The workforce analyzer also generates a model for vitality for the groups of people from payroll data for the groups of people. The model shows the vitality for the groups of people as a measure of performance for the groups of people based on the payroll data. Further, the workforce analyzer identifies proportions of the payroll data for the groups of people in the payroll data. The proportions of the payroll data for the groups of people are proportions of sets of the payroll data defined by the number of characteristics about the groups of people. Still further, the workforce analyzer adjusts the model based on a difference between the proportions of the payroll data and desired proportions for the payroll data for the groups of people in the payroll data. The model for the vitality has a desired level of accuracy and enables changing the workforce based on a result obtained from using the model.

In yet another illustrative embodiment, a computer program product for identifying a vitality for a workforce comprises a computer readable storage media, first program code, second program code, third program code, and fourth program code, stored on the computer readable storage media. The first program code is selects groups of people in the workforce based on a number of characteristics about the groups of people. The second program code generates a model for the vitality for the groups of people from payroll data for the groups of people. The model shows the vitality for the groups of people as a measure of performance for the groups of people based on the payroll data. The third program code identifies proportions of the payroll data for the groups of people in the payroll data. The proportions of the payroll data for the groups of people are proportions of sets of the payroll data defined by the number of characteristics about the groups of people. The fourth program code adjusts the model based on a difference between the proportions of the payroll data and desired proportions for the payroll data for the groups of people in the payroll data. The model for the vitality has a desired level of accuracy and enables changing the workforce based on a result obtained from using the model.

In still another illustrative embodiment, a method for identifying a workforce vitality is presented. A group of dimensions for reports about the workforce vitality is selected. The group of dimensions are a number of characteristics about groups of people in a workforce. The workforce vitality is calculated by a computer system from payroll data for the groups of people. The payroll data is from a group of employers. The reports about the workforce vitality are generated by the computer system. The reports show the workforce vitality as a measure of performance for the groups of people based on the payroll data. The reports have a desired level of accuracy that enables selecting which of the groups of people have a greater need for improvements to the workforce vitality for the group of employers.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a workforce management environment in accordance with an illustrative embodiment;

FIG. 2 is an illustration of a block diagram of a measure for performance for the vitality of the workforce in accordance with an illustrative embodiment;

FIG. 3 is an illustration of a block diagram of a model for the vitality for the groups in a workforce in accordance with an illustrative embodiment;

FIG. 4 is an illustration of a block diagram of proportions of payroll data in accordance with an illustrative embodiment;

FIG. 5 is an illustration of a block diagram of components of a workforce analyzer in accordance with an illustrative embodiment;

FIG. 6 is an illustration of a block diagram of components of a workforce analyzer in accordance with an illustrative embodiment;

FIG. 7 is an illustration of a block diagram of the characteristics for groups of people in a workforce in accordance with an illustrative embodiment;

FIG. 8 is an illustration of a block diagram of a payroll entry in accordance with an illustrative embodiment;

FIG. 9 is an illustration of a block diagram of a payroll entry in accordance with an illustrative embodiment;

FIG. 10 is an illustration of a block diagram of a payroll entry in accordance with an illustrative embodiment;

FIG. 11 is an illustration of a report in accordance with an illustrative embodiment;

FIG. 12 is an illustration of a graphical user interface for identifying the workforce vitality of the groups in the workforce in accordance with an illustrative embodiment;

FIG. 13 is an illustration of a flowchart of a process for identifying the vitality of the workforce in accordance with an illustrative embodiment;

FIG. 14 is an illustration of a flowchart of a process for generating a model for vitality of groups in a workforce in accordance with an illustrative embodiment;

FIG. 15 is an illustration of a flowchart of a process for identifying proportions of groups in payroll data in accordance with an illustrative embodiment;

FIG. 16 is an illustration of a flowchart of a process for adjusting a model for vitality of groups in a workforce in accordance with an illustrative embodiment;

FIG. 17 is an illustration of a flowchart of a process for performing an analysis in accordance with an illustrative embodiment;

FIG. 18 is an illustration of a flowchart of a process for identifying and initiating workforce actions in accordance with an illustrative embodiment; and

FIG. 19 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that the concept of workforce management may be viewed as a method of organizing human actions that is based on the fundamental building blocks of gathering the workforce information, analyzing the workforce information, and taking appropriate action to organize the workforce based on the analysis of the workforce information. Using these basic building blocks, various specific systems and methods have been developed. For example, without limitation, in a time and motion study the workforce information may include information obtained by direct and continuous observation of the workforce performing a task using a timekeeping device. This workforce information obtained by direct observations then may be analyzed and used to rearrange the work performed by the workforce to improve the efficiency of the workforce.

The different illustrative embodiments recognize and take into account that current systems and methods of workforce management may be limited in various ways. The illustrative embodiments implement and integrate the basic building blocks of workforce management into something significantly more by applying the basic building blocks in a meaningful way to improve workforce management beyond that provided by current uses of these basic building blocks. For example, the illustrative embodiments expand upon and integrate the basic building blocks of workforce management into something significantly more by integrating workforce information including payroll data with a dynamically adjustable model to identify the vitality of the workforce.

The illustrative embodiments recognize and take into account that identifying the workforce vitality as currently identified is often not as accurate as desired because of one or both of the manner in which the workforce vitality is identified and the sources of data used for identifying workforce vitality.

The illustrative embodiments recognize and take into account that models may be developed and used in performing the analysis of the workforce. For example, one type of model may include the vitality of the workforce.

The illustrative embodiments recognize and take into account that many factors may affect the vitality of the people in the workforce. For example, an employee may have recently changed job roles. This change between job roles may result in a significant change in the vitality of the employee. As another example, an employee may be a new hire. In this example, a significant amount of time may pass before the vitality of the new hire meets expectations. As still another example, wages for an employee may not be in line with what other similar employees are receiving. In this example, when the employee's wage is less than what the employee expects, the employee may be less productive or have less commitment to employer goals.

The illustrative embodiments recognize and take into account that these and other factors may affect the vitality of different employees in the workforce in different ways. For example, an employee in a region where new hires are hard to find may expect higher compensation as compared to regions in which new hires are easier to find. As another example, an emotional commitment to employer goals may be different for different industries.

The illustrative embodiments recognize and take into account that the data used to identify the vitality of the workforce may be unavailable, incomplete, incorrect, or some combination thereof. The illustrative embodiments recognize and take into account that missing data, unavailable data, incomplete data, or incorrect data may result in different amounts of data being present at different times when the data is collected. Further, the amounts of data available for the characteristics of the groups used in the analysis of the vitality may be different. For example, the characteristic of the group is geographic location. Less data may be present for persons in the Midwest as compared to persons on the West Coast. For an analysis of the vitality, wage information may be analyzed from payroll data for persons in those two geographic locations. The amount of wage data may be unequal such that the proportion of wage data between the two locations is greater than desired for the analysis. As a result, the proportion of payroll data for groups in payroll data may be different than the expected proportion.

As one solution to these technical problems, the illustrative embodiments provide a process for identifying the vitality of the workforce with a desired level of accuracy that enables selecting groups in the workforce that have a greater need for improvements to the vitality.

Thus, the illustrative embodiments provide a method and apparatus for identifying the vitality of a workforce. In one illustrative example, groups of people in the workforce base are selected based on a number of characteristics about the groups. A computer system generates a model for the vitality of the groups from payroll data of the groups, wherein the model shows the vitality of the groups as a measure of performance of the groups based on the payroll data. The computer system identifies the proportion of the payroll data for the groups in the payroll data. A proportion of the payroll data for the groups is proportion for sets of the payroll data defined by the number of characteristics about the groups. The computer system adjusts the model based on the difference between the proportion of the payroll data and desired proportion of the payroll data for the groups in the payroll data, wherein the model has a desired level of accuracy and enables changing the workforce based on a result obtained from using the model.

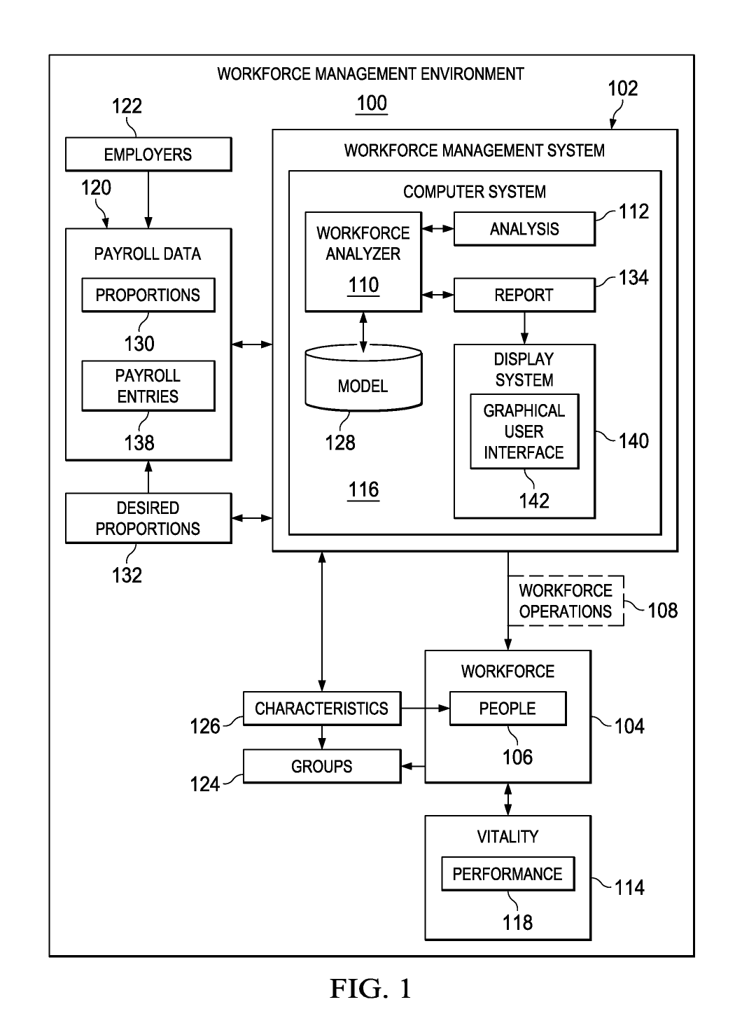

With reference now to the figures and in particular with reference to FIG. 1, an illustration of a block diagram of a workforce management environment is depicted in accordance with an illustrative embodiment. Workforce management environment 100 includes workforce management system 102. Workforce management system 102 is used to perform operations with respect to workforce 104. As depicted, workforce 104 is people 106 who are employed or actively looking for employment.

In the illustrative example, workforce management system 102 may be used to perform workforce operations 108 on workforce 104. Workforce operations 108 are actions. These actions may be performed by at least one of people in the workforce, a computer system, a combination of people and computer systems, or any other suitable combination of entities that can carry out actions for the workforce. Workforce operations 108 may include, for example, at least one of hiring, job assigning, reassigning, relocating, laying off, asset purchasing, training, reviewing, or other suitable operations.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, workforce analyzer 110 may be used to perform analysis 112 on workforce 104. As depicted, workforce analyzer 110 identifies workforce operations 108. As depicted, workforce analyzer 110 is a component that also identifies vitality 114 for workforce 104 in this example.

In the illustrative example, workforce analyzer 110 may be implemented in software, hardware, firmware or a combination thereof. When software is used, the operations performed by workforce analyzer 110 may be implemented in program code configured to run on hardware, such as a processor unit. When firmware is used, the operations performed by workforce analyzer 110 may be implemented in program code and data and stored in persistent memory to run on a processor unit. When hardware is employed, the hardware may include circuits that operate to perform the operations in workforce analyzer 110.

As depicted, workforce analyzer 110 is implemented in computer system 116. Computer system 116 is comprised of one or more computers. When more than one computer is present in computer system 116, those computers may communicate with each other through a communications media such as a network.

In this illustrative example, vitality 114 of workforce 104 is a measure of performance 118 of workforce 104. As depicted, vitality 114 is identified using payroll data 120. Payroll data 120 may be stored in a database, multiple databases, or in other types of repositories.

Payroll data 120 is information about people 106 in workforce 104. Payroll data 120 may be reported by employers 122 of workforce 104. Payroll data 120 may include, for example, company data, employee data, compensation, benefits, vacation time, sick time, company, address, job, and other suitable information.

In this illustrative example, payroll data for the groups is information reported by employers about the workforce. As depicted, payroll data 120 may be for selected groups of employers of different sizes.

Payroll data 120 may also include data from different sources. For example, payroll data 120 may include data from an employer with 50 or more employees and other data from employers with fewer than 50 employees.

In the illustrative example, workforce 104 may be divided into groups 124 based on characteristics 126 about groups 124. In particular, characteristics 126 are about people 106 in workforce 104. A characteristic is an indication of a feature or quality about people 106. For example, characteristics 126 of people 106 in workforce 104 may be selected from at least one of industry, firm size, type of employment, employment status, wage by tier, amount of tenure, gender, age group, or other suitable types of characteristics for people in the workforce.

A number of characteristics 126 may be used to create a group in groups 124. As used herein, the phrase “a number of,” when used with reference items, means one or more items. For example, a number of characteristics 126 is one or more of characteristics 126.

In this illustrative example, characteristics 126 of groups 124 of people identify differences, similarities, or both between the people 106 in workforce 104. For example, a characteristic of workforce 104 may be the type of industry for workforce 104. In this example, a group of people 106 working for a particular industry is different than another group of people 106 working in another industry.

As depicted, workforce analyzer 110 selects groups 124 of people 106 in workforce 104 based on a number of characteristics 126 about groups 124. Workforce analyzer 110 generates model 128 for vitality 114 for groups 124 from payroll data 120 for groups 124. In this illustrative example, model 128 shows vitality 114 for groups 124 as the measure of performance 118 for groups 124 based on payroll data 120.

As depicted, model 128 for vitality 114 for groups 124 is a data structure that contains information about relationships between payroll data 120 and vitality 114 for groups 124. In this particular example, model 128 takes the form of a table showing vitality 114 for groups 124 as the measure of performance 118 for groups 124 based on payroll data 120. Of course, model 128 may use other data structures other than a table. For example, model 128 may be a flat file, a database, a linked list, or some other suitable data structure.

Workforce analyzer 110 identifies proportions 130 of payroll data 120 for groups 124 in payroll data 120. As depicted, proportions 130 of payroll data 120 for groups 124 is proportions 130 of sets of payroll data 120 defined by the number of characteristics 126 about groups 124. As used herein, “proportions of a whole” are parts, shares, or numbers considered in comparative relation to the whole. For example, proportions 130 of payroll data 120 for groups 124 in payroll data 120 are parts, shares, or numbers of individuals in groups 124 considered in comparative relation to numbers of individuals in payroll data 120. As used herein, the phrase “sets of,” when used with reference to items, means one or more groups of items. For example, sets of payroll data 120 is one or more groups 124 in payroll data 120.

In the illustrative example, proportions 130 of payroll data 120 for groups 124 in payroll data 120 may be expressed as the percentages of the number of payroll entries for groups 124 in payroll data 120. For example, when half of the payroll entries in payroll data 120 are for a particular group, the proportion of payroll data 120 for that particular group is 50 percent. In this illustrative example, desired proportions 132 of payroll data 120 are the desired percentages for the number of payroll entries 138 in payroll data 120 for groups 124. Payroll entries 138 are records of employment information about employees. The records may be for periods of time. For example, a period of time for the records may be selected from at least one of a particular year, a particular quarter of the year, a particular month of the year, or the period between two calendar dates. The records may include data selected from at least one of company data, employee data, compensation data, benefits, vacation time, sick time, addresses, job type, or other suitable information.

As depicted, workforce analyzer 110 adjusts model 128 based on a difference between proportions 130 of payroll data 120 and desired proportions 132 of payroll data 120 for groups 124 in payroll data 120. In this illustrative example, desired proportions 132 of payroll data 120 for groups 124 in payroll data 120 are identified from payroll data originating from a comprehensive Quarterly Survey of Employment and Wages produced by the Bureau of Labor Statistics. Desired proportions 132 may also be identified from other suitable sources. Those sources may be selected from at least one of census data for groups 124 in workforce 104, or other suitable sources of information that specify expected proportions for groups 124 in payroll data 120. Model 128 has a desired level of accuracy and enables changing the workforce based on a result obtained from using model 128. Model 128 shows vitality 114 for groups 124 as the measure of performance 118 for groups 124 based on desired proportion 132 of payroll data 120 for groups 124 after adjusting model 128 based on differences.

In this illustrative example, workforce analyzer 110 may generate model 128 in response to an event. Events may be periodic or non-periodic. For example, workforce analyzer 110 may generate model 128 when at least one of a period of time has passed or a structural change to an economy has occurred that affects the desired level of accuracy. In the illustrative example, the period of time may be, for example, each time a payroll period occurs, weekly, monthly, or some other suitable period of time.

A structural change to an economy is a change that affects how the economy works. Structural changes to the economy may be selected from at least one of new technologies, changes to laws, or changes to social interactions between people in a workforce. An economy is a result of production by the workforce in a region. This result is defined by monetary rewards earned by the workforce for work produced. For example, the economy may be the economy of a nation, a state, a geographic region, the world, or an industry.

In this manner, workforce management system 102 operates to have a technical effect that provides a technical solution to identify the vitality of the workforce with a desired level of accuracy that enables workforce planning. In other words, workforce analyzer 110 in workforce management system 102 generates model 128 that enables workforce planning in a manner that is more accurate than currently available with current analysis techniques.

With model 128, workforce analyzer 110 may generate report 134. As depicted, report 134 for model 128 shows which of groups 124 selected in workforce 104 have a greater need for improvements based on the vitality of the groups.

Further, in this illustrative example, workforce analyzer 110 may identify workforce operations 108. A workforce operation in workforce operations 108 is an action that has an effect on workforce 104. In the illustrative example, workforce analyzer 110 identifies workforce operations 108 based on analysis 112 performed using model 128. Analysis 112 is a description of the vitality of the workforce. In the illustrative example, analysis 112 may be identified from model 128. Additionally, workforce analyzer 110 may perform or initiate workforce operations 108.

As depicted, computer system 116 includes display system 140. In this illustrative example, display system 140 is a group of display devices. A display device in display system 140 may be selected from one of a liquid crystal display (LCD), a portable phone, a personal digital assistant, and other suitable types of display devices.

In this illustrative example, display system 140 includes graphical user interface 142. In this illustrative example, workforce analyzer 110 displays at least one of report 134, analysis 112, workforce operations 108, or other suitable information in graphical user interface 142. Workforce analyzer 110 may receive user input selecting characteristics 126 of groups 124 for report 134. Workforce analyzer 110 may also receive user input selecting an operation to perform in workforce operations 108.

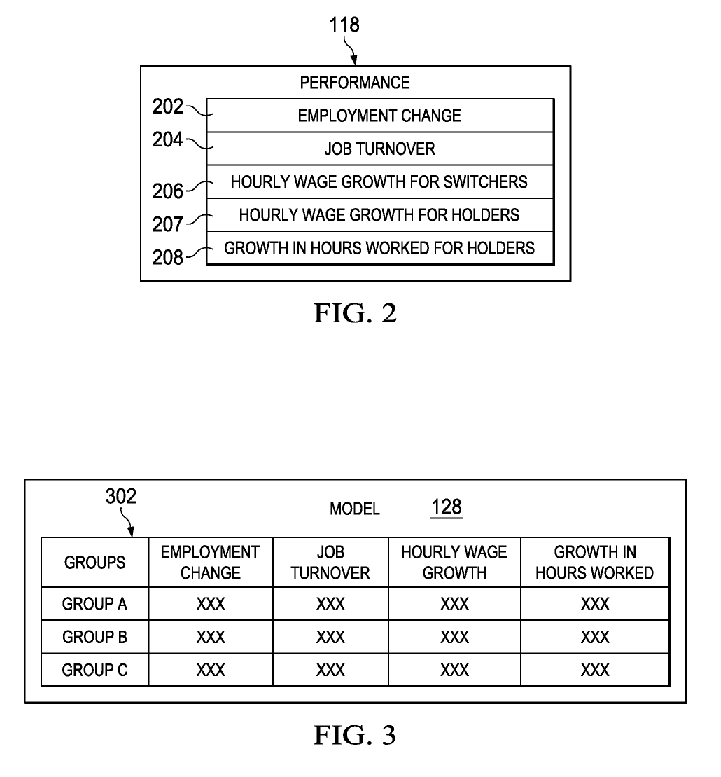

With reference next to FIG. 2, an illustration of a block diagram of a measure for performance for vitality for a workforce is depicted in accordance with an illustrative embodiment. As depicted, an example of the measure of performance 118 is shown for workforce 104 in FIG. 1.

In this illustrative example, the measure of performance 118 is described using statistics identified from payroll data 120 in FIG. 1. A statistic is a value that represents information identified from data. For example, a statistic identified from payroll data 120 is a value representing information identified from the payroll data 120.

As depicted, the statistics in the measure of performance 118 include employment change 202, job turnover 204, hourly wage growth for switchers 206, hourly wage growth for holders 207, and growth in hours worked for holders 208.

As depicted, employment change 202 is a change in the number of people 106 in FIG. 1 employed in workforce 104. For example, employment change 202 may be calculated based on the difference in the number of people 106 employed in the workforce between two periods of time.

In the illustrative example, job turnover 204 is the rate at which people 106 in workforce 104 switch between employers 122 in FIG. 1 in comparison with the number of people 106 that stay with the same employer. People in the workforce that switch between employers in a period of time are referred to as job switchers for the period of time. The period of time may be, for example, a quarter, 2 quarters, 3 quarters, or some other suitable period of time.

People that stay with the same employer are referred to as job holders. For example, job turnover 204 for a period of time may be calculated as the number of job switchers divided by the sum of the number of job holders and the number of job switchers.

As depicted, hourly wage growth for switchers 206 is the rate of growth for hourly wages of people that switched jobs in the workforce. Hourly wage growth for holders 207 is the rate of growth for hourly wages of people that stayed with the same employer.

For example, hourly wage growth for holders 207 may be calculated for job holders between two periods of time. In this illustrative example, the two periods of time may be a current quarter of the year and a previous quarter. As another example, hourly wage growth for switchers 206 may be calculated for job switchers between a current quarter of the year and a previous quarter. A quarter of a year is three months of the year selected from at least one of the first three months of the year, the second three months of the year, the third three months of the year, or the fourth three months of the year. A previous quarter may be the quarter that immediately preceded the current quarter or the same quarter in a previous year.

In this illustrative example, growth in hours worked for holders 208 is a change in the average number of hours worked by people in the workforce. For example, growth in hours worked for holders 208 may be calculated based on a difference in the average number of hours job holders worked between a current quarter and a previous quarter.

Turning to FIG. 3, an illustration of a block diagram of a model for the vitality of the groups in a workforce is depicted in accordance with an illustrative embodiment. As depicted, an example of an implementation of model 128 is shown for groups 124 in workforce 104 in FIG. 1.

In this illustrative example, model 128 includes table 302. As depicted, table 302 shows relationships between payroll data 120 and vitality 114 for groups 124 of people 106 in workforce 104 in FIG. 1. As depicted, the rows in table 302 are an example of groups 124. The columns in table 302 are an example of the statistics in performance 118 in FIG. 2.

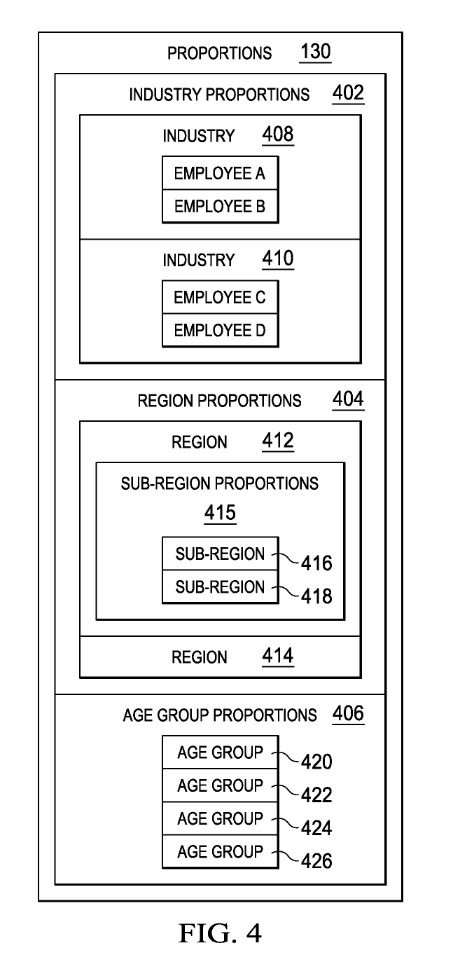

Turning next to FIG. 4, an illustration of a block diagram of proportions of payroll data is depicted in accordance with an illustrative embodiment. As depicted, an example of proportions 130 of payroll data 120 is shown for groups 124 of people 106 in workforce 104 in FIG. 1.

In this illustrative example, proportions 130 includes industry proportions 402, region proportions 404, and age group proportions 406. Industry proportions 402, region proportions 404, and age group proportions 406 are examples of proportions 130 of sets of payroll data 120 defined by the number of characteristics 126 in FIG. 1 about groups 124.

As depicted, industry proportions 402 include industry 408 and industry 410. In this illustrative example, industry 408 and industry 410 are combinations of types of industries for workforce 104. For example, industry 408 may be selected from at least one of construction; education and health care; finance, real estate, and information; manufacturing; other non public services; professional services; trade and transportation; or other suitable combinations of types of industries. In this depicted example, industry 410 may be another combination of types of industries other than the combination of types in industry 408.

In this illustrative example, employee A and employee B have the characteristic of being employed in industry 408. As also depicted, employee C and employee D have the characteristic of being employed in industry 410. The proportion of the payroll data for industry 408 is a ratio of the number of employees in industry 408 to the total number of employees in workforce 104 and the proportion of the payroll data for industry 410 is a ratio of the number of employees in industry 410 to the total number of employees in workforce 104.

In this illustrative example, region proportions 404 include geographic areas for a portion of people 106 in workforce 104. These geographic areas are at least one of locations where the portion of people 106 work, locations where the portion of people 106 live, locations where the employers of the portion of people 106 are located, locations where the employers of the portion of people 106 have their corporate headquarters, or other suitable types of locations for identifying statistics about payroll data 120. For example, a geographic area is selected from at least one of a hemisphere of the planet, a continent, a nation, a region of a nation, or a sub-region of a nation. When the workforce is people working in the United States of America, the regions for the United States of America are selected from at least one of northeast, midwest, south, west, or other suitable type of regions.

In the illustrated example, region proportions 404 include region 412 and region 414. Region 412 includes sub-region proportions 415. Sub-region proportions 415 are portions of region 412. A sub-region is a portion of a larger region. A sub-region proportion is the percentage of people 106 in workforce 104 in the portion of the larger region. A sub-region proportion of a nation is a state, a county, a city, a sub-division, a street, a group of buildings, a building, or some other suitable type of sub-region.

As depicted, sub-region proportions 415 include sub-region 416 and sub-region 418. For example, when workforce 104 is people working in the United States of America, region 412 may be the south, and region 414 may be the northeast. In this example, sub-region 416 may be the state of Texas and sub-region 418 may be the state of Florida. In this example, sub-region proportions 415 represent a portion of people 106 in workforce 104 in region 412.

As depicted, age group proportions 406 include age group 420, age group 422, age group 424, and age group 426. Age group 420, age group 422, age group 424, and age group 426 may be any suitable range of ages for people 106 in workforce 104. In this illustrative example, age group 420 is for 16 to 24-year-old people in workforce 104, age group 422 is for 25 to 34-year-old people in workforce 104, age group 424 is for 35 to 55-year-old people in workforce 104, and age group 424 is for people 55 years or older in workforce 104. In this illustrative example, the portion of people 106 in workforce 104 younger than the people in age group 420 make up the remaining proportion of people 106 in workforce 104 that are not in age group proportions 406.

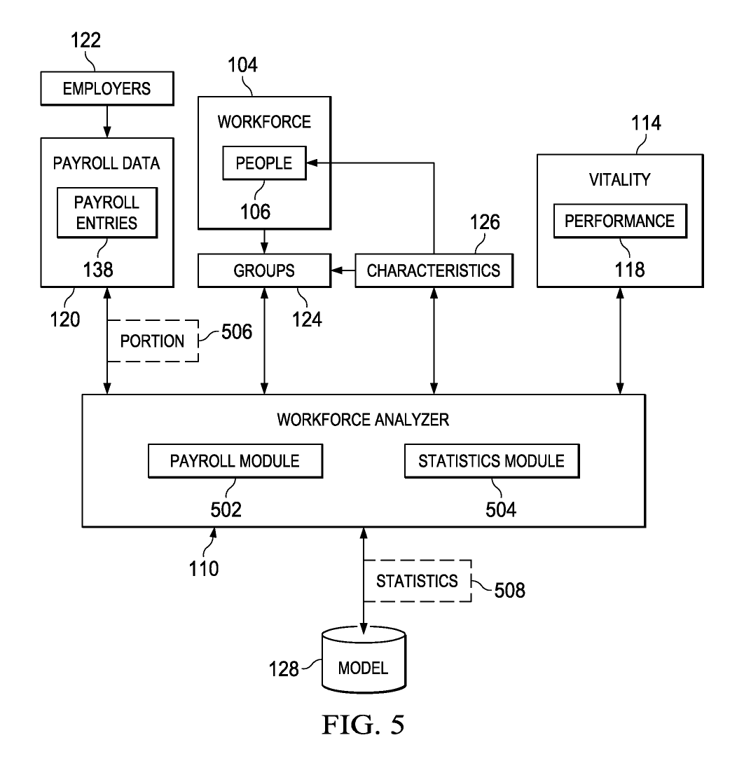

Turning now to FIG. 5, an illustration of a block diagram of components of a workforce analyzer is depicted in accordance with an illustrative embodiment. In this figure, an example of components that may be used in workforce analyzer 110 in FIG. 1 is shown.

As depicted, workforce analyzer 110 includes payroll module 502 and statistics module 504. These two components may be hardware, software, or a combination of hardware and software.

In the illustrative example, payroll module 502 identifies portion 506 of payroll entries 138 in payroll data 120 based on a number of payroll entries 138 in payroll data 120 that match characteristics 126 of groups 124. Payroll module 502 identifies groups 124 of people 106 in workforce 104 from portion 506 of payroll entries 138 in payroll data 120. Payroll module 502 may also perform quality control checks on payroll entries 138. These quality control checks insure portion 506 does not include any duplicate or invalid payroll entries.

Statistics module 504 identifies statistics 508 for groups 124 as the measure of performance 118 of groups 124. Statistics 508 are selected from at least one of rates of change as a difference in numbers between periods of time, rates of change as a percentage between periods of time, totals, averages, or other suitable types of statistics that represent information about groups 124. For example, when a statistic is for the number of people employed in a group in the workforce, the statistic may be selected from at least one of a total number of people employed in the workforce for a period of time, an average number of people employed in the workforce in the period of time, or a rate of change of a number or percentage for a difference in the number of people employed between two periods of time.

In this illustrative example, statistics module 504 identifies statistics 508 using at least one of descriptive statistics, inferential statistics, or some other suitable statistics methodology. As used herein, descriptive statistics is a statistical methodology used to quantitatively describe values that summarize information in data. For example, statistics module 504 may use descriptive statistics to generate at least one of totals, averages, rates of change, or differences over time for groups 124 in payroll data 120. Inferential statistics is a statistical methodology used to make predictions about an entire group of people from a sample that is representative of the group of people. For example, when payroll data 120 only includes a portion of payroll data for workforce 104, statistics module 504 may use inferential statistics to generate predictions for statistics 508 for groups 124 in workforce 104 based on payroll data 120.

Statistics module 504 identifies statistics 508 from portion 506 of payroll data 120 for groups 124. Statistics module 504 generates model 128 for vitality 114 of groups 124 from statistics 508. In the illustrative example, the amount of time and resources needed to generate model 128 is reduced because workforce analyzer 110 only uses portion 506 of payroll entries 138 to generate model 128.

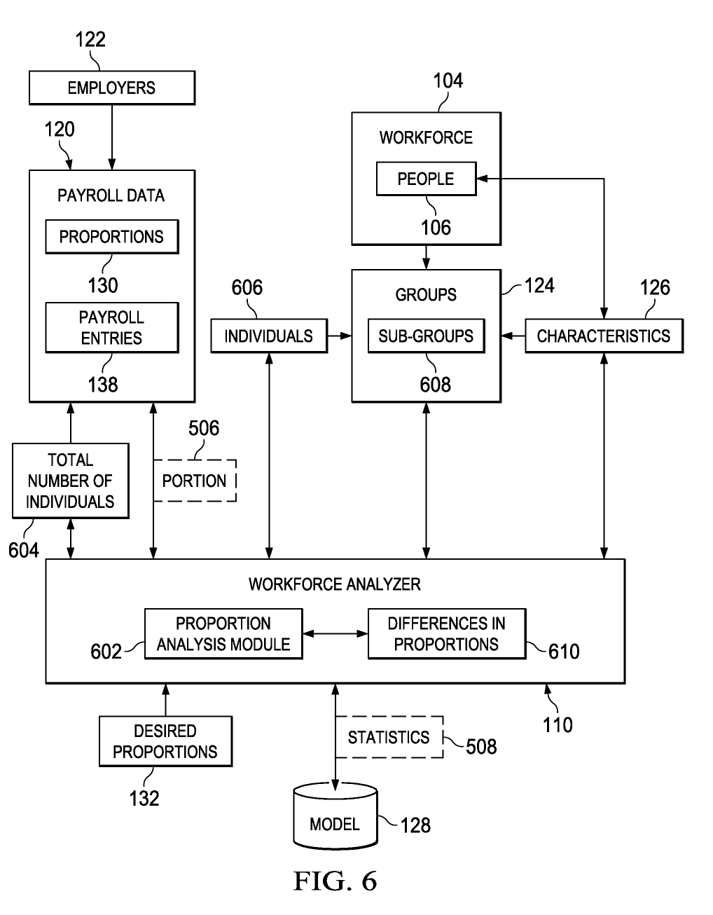

Turning next to FIG. 6, an illustration of a block diagram of components of a workforce analyzer is depicted in accordance with an illustrative embodiment. In this figure, another example of components that may be used in workforce analyzer 110 in FIG. 1 is shown.

As depicted, workforce analyzer 110 includes proportion analysis module 602. Proportion analysis module 602 may be hardware, software, or a combination of hardware and software.

In this illustrative example, proportion analysis module 602 identifies total number of individuals 604 in payroll data 120 from payroll entries 138. As depicted, total number of individuals 604 is the number of unique individuals in payroll data 120. For example, when the marital status of an individual in payroll data 120 changes during a period of time resulting in a name change, proportion analysis module 602 only counts that individual as one individual. As another example, when an individual switches employers resulting in payroll data 120 having payroll entries for the individual from two different companies, proportion analysis module 602 only counts that individual as one individual.

As depicted, proportion analysis module 602 also identifies individuals 606 in groups 124 as the total number of individuals in each group in groups 124. In this illustrative example, proportion analysis module 602 identifies individuals 606 from payroll entries 138 in payroll data 120.

As depicted, groups 124 may include sub-groups 608. When a sub-group is present in sub-groups 608 for a particular group in groups 124, individuals 606 of the group is the total number of individuals in the sub-group. For example, when the group is a region and the sub-group is a number of sub-regions then the total number of individuals in the region is calculated as the total number of individuals in the sub-regions.

In this illustrative example, proportion analysis module 602 identifies proportions 130 of people 106 in groups 124 based on the total number of individuals 604 in groups 124 and total number of individuals 604 in payroll data 120.

As depicted, proportion analysis module 602 identifies differences in proportions 610 between proportions 130 of payroll data 120 and desired proportions 132 of payroll data 120 for groups 124 in payroll data 120. In this illustrative example, proportion analysis module 602 may also identify desired proportions 132. For example, proportion analysis module 602 may identify desired proportions 132 selected from at least one of census data for groups 124 in workforce 104, or other suitable sources of information that specify expected proportions for groups 124 in payroll data 120. For example, census data may indicate the percentages of workers by age group. In this example, when groups 124 are based on the age groups of the people in payroll data 120, proportion analysis module 602 identifies the differences in proportions 610 as the difference between proportions 130 and proportions indicated in the census data. In this illustrative example, proportion analysis module 602 adjusts statistics 508 in model 128 based on differences in proportions 610 of groups 124.

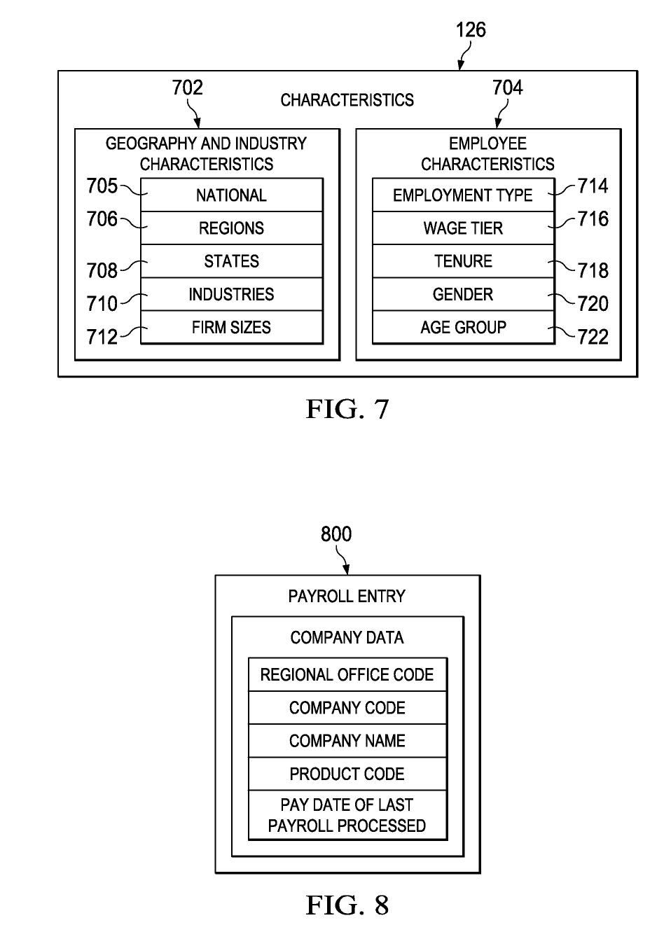

With reference next to FIG. 7, an illustration of a block diagram of the characteristics of the groups of people in a workforce is depicted in accordance with an illustrative embodiment. As depicted, an example of characteristics 126 is shown for groups 124 of people 106 in workforce 104 in FIG. 1.

In this illustrative example, characteristics 126 include geography and industry characteristics 702 and employee characteristics 704. As depicted, geography and industry characteristics 702 include national 705, regions 706, states 708, industries 710, and firm sizes 712. In this illustrative example, employee characteristics 704 include employment type 714, wage tier 716, tenure 718, gender 720, and age group 722.

As depicted, firm sizes 712 are a characteristic of an employer identifying a range of the number of employees employed by an employer. The number of employees may be an average number of employees over a period of time, a highest number of employees at one point in time over the period of time, a minimum number of employees at one point in time over the period of time, or a total number of employees employed by the employer over the period of time. In this illustrative example, firm sizes 712 are selected from at least one of 1-49 employees, 50-499 employees, 500-999 employees, 500+ employees, 1000+ employees, or some other suitable range of employees.

In this illustrative example, employment type 714 is a characteristic of the type of employment of employees. Employment type 714 may be, for example, selected from at least one of full-time employment, part-time employment, or some other suitable type of employment for employees.

As depicted, wage tier 716 is a characteristic of wages earned by employees. In this illustrative example, wage tier 716 is selected from at least one of less than twenty thousand dollars in annual salary, twenty thousand to fifty thousand in annual salary, fifty thousand to seventy-five thousand in annual salary, above seventy-five thousand in annual salary, or some other suitable range of wages earned by employees.

In the illustrative example, tenure 718 is a characteristic of the duration of time an employee has been with a particular employer. In this illustrative example, tenure 718 is selected from at least one of less than one year, one to three years, three to five years, five to ten years, or greater than ten years. Other types of tenure characteristics may also be used in workforce management environment 100 in FIG. 1.

For example, another type of tenure characteristic may be for at least one of a duration of time an employee has been with a particular employer in years, a duration of time in months an employee has been with a particular employer without unexcused gaps, a duration of time an individual has been employed in a particular type of job without regard to employer, or other suitable types of length of employment of an individual.

With reference next to FIG. 8, an illustration of a block diagram of a payroll entry is depicted in accordance with an illustrative embodiment. As depicted, payroll entry 800 is an example of a payroll entry in payroll entries 138 in payroll data 120 in FIG. 1.

In this illustrative example, payroll entry 800 includes data fields about company data. A workforce analyzer may use payroll entry 800 to identify employers of employees in payroll data 120 in FIG. 1.

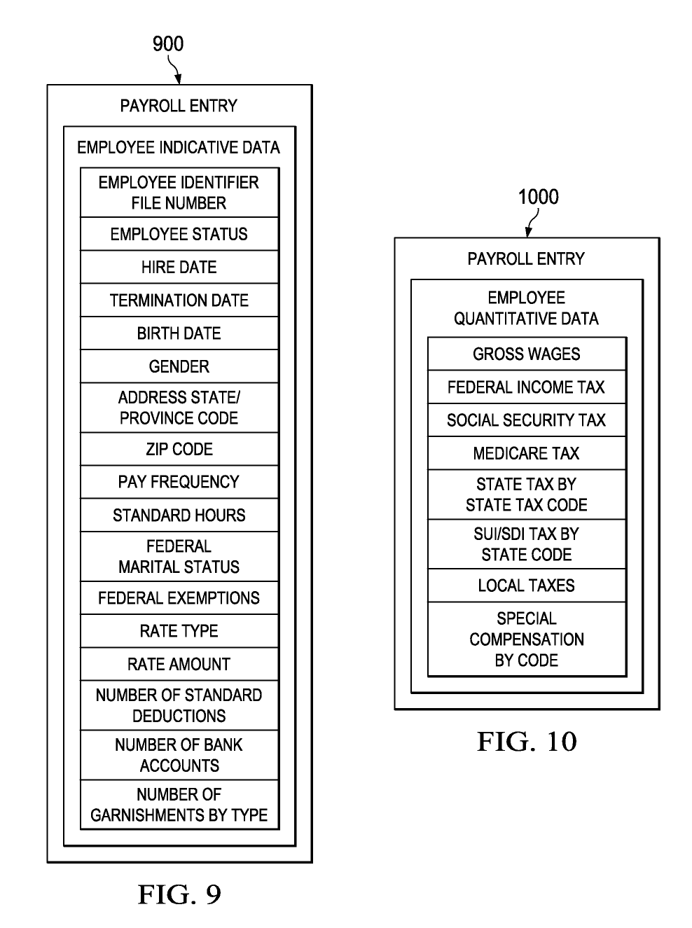

With reference next to FIG. 9, an illustration of a block diagram of a payroll entry is depicted in accordance with an illustrative embodiment. As depicted, payroll entry 900 is another example of a payroll entry in payroll entries 138 in payroll data 120 in FIG. 1.

In this illustrative example, payroll entry 900 includes data fields about employees in workforce 104. A workforce analyzer may use payroll entry 900 to identify groups 124 of people 106 in workforce 104 from payroll data 120 in FIG. 1.

With reference next to FIG. 10, an illustration of a block diagram of a payroll entry is depicted in accordance with an illustrative embodiment. As depicted, payroll entry 1000 is a further example of a payroll entry in payroll entries 138 in payroll data 120 in FIG. 1.

In this illustrative example, payroll entry 1000 includes data fields about employee wages. A workforce analyzer may use payroll entry 1000 to identify groups 124 of people 106 in workforce 104 from payroll data 120 in FIG. 1.

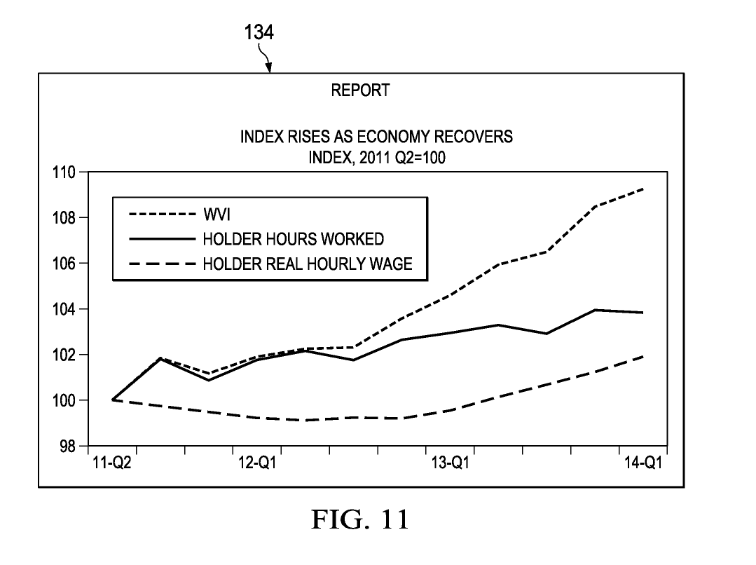

With reference next to FIG. 11, an illustration of a report is depicted in accordance with an illustrative embodiment. As depicted, an example of report 134 is shown for model 128 in FIG. 1.

In this illustrative example, report 134 is shown as a graph of statistics over a period of time for a group of job holders in a workforce. As depicted, the x-axis of the graph shows the period of time and the y-axis of the graph shows a change in the vitality of the job holders from a baseline of 100. The statistics shown on the graph include the vitality of job holders in a workforce, the average number of hours the job holders worked, and the average hourly wage of the job holders.

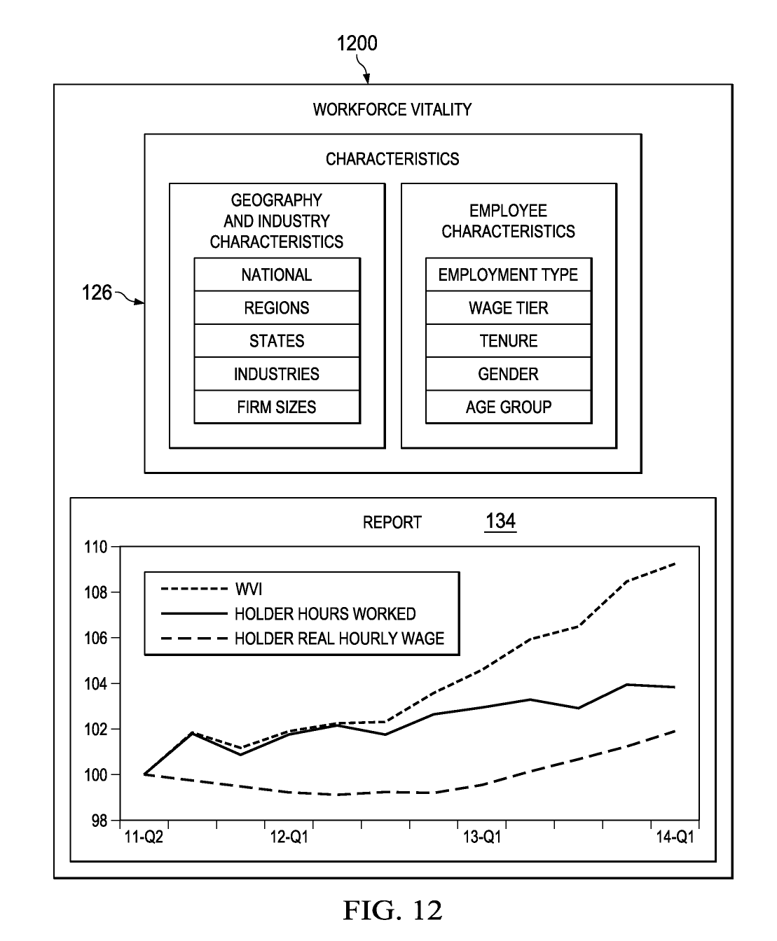

With reference next to FIG. 12, an illustration of a graphical user interface for identifying the workforce vitality of the groups in the workforce is depicted in accordance with an illustrative embodiment. As depicted, workforce vitality 1200 is an example of graphical user interface 142 in FIG. 1.

In this illustrative example, an operator provides user input selecting characteristics 126 for report 134. When characteristics 126 are selected, graphical user interface 142 in FIG. 1 displays report 134.

The illustration of workforce management environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, workforce analyzer 110 may be implemented as a separate component from workforce management system 102. Also, in some illustrative examples, workforce analyzer 110 may be a distributed application located on multiple computers in computer system 116. As another example, the statistics in the measure of performance 118 may also include at least one of vitality of the workforce for the current period and for the previous period, percent of change in vitality of the workforce between the current period and the previous period, or other suitable types of statistics.

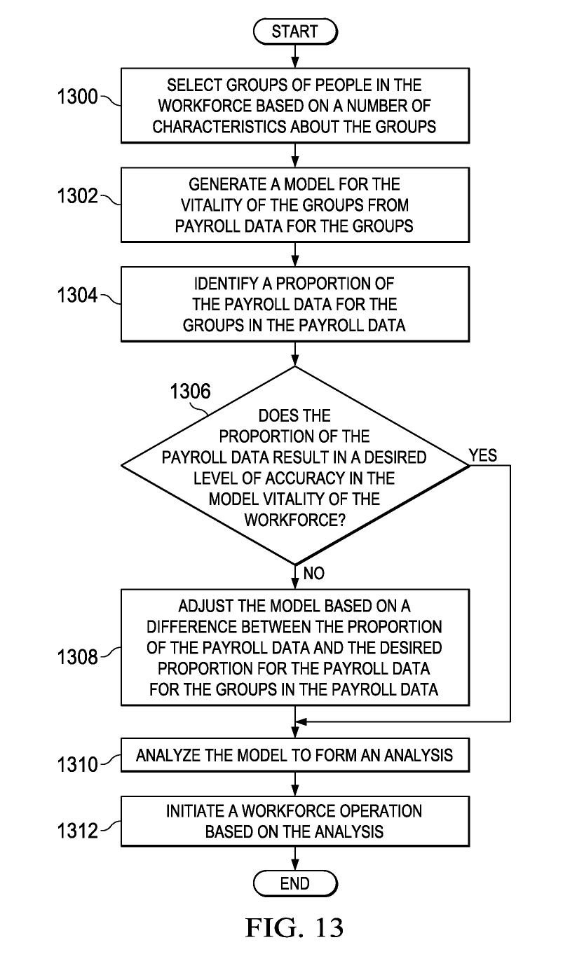

Turning next to FIG. 13, an illustration of a flowchart of a process for identifying the vitality of the workforce is depicted in accordance with an illustrative embodiment. The process illustrated in FIG. 13 may be implemented in workforce management environment 100 in FIG. 1. In particular, the different operations illustrated in this flowchart may be implemented using workforce analyzer 110.

The process begins by selecting groups of people in the workforce based on a number of characteristics about the groups (operation 1300). The process then generates a model for the vitality of the groups from payroll data for the groups (operation 1302). The model in operation 1302 shows the vitality of the groups as a measure of performance for the groups based on the payroll data.

The process identifies a proportion of the payroll data for the groups in the payroll data (operation 1304). In operation 1304, the proportion of the payroll data for the groups is the proportion of sets of the payroll data defined by the number of characteristics about the groups.

Next, a determination is made as to whether the proportion of the payroll data results in a desired level of accuracy in the model vitality of the workforce (operation 1306). In operation 1306, the determination may be made by identifying a difference between the proportion of the payroll data and the desired proportion for the payroll data. If the difference in the proportion of payroll data is greater than the desired threshold from the desired proportion for the payroll data, then an adjustment may be needed. In this illustrative example, the determination may be made for each characteristic that will be used in the model.

If the proportion of the payroll data does not provide a desired level of accuracy in the model, the process adjusts the model based on a difference between the proportion of the payroll data and the desired proportion for the payroll data for the groups in the payroll data (operation 1308). The model has a desired level of accuracy and enables changing the workforce based on a result obtained from using the model.

The process analyzes the model to form an analysis (operation 1310). The process then initiates a workforce operation based on the analysis (operation 1312) with the process terminating thereafter. With reference again to operation 1306, if the proportion of the payroll data provides a desired level of accuracy in the model, the process proceeds to operation 1310 as described above.

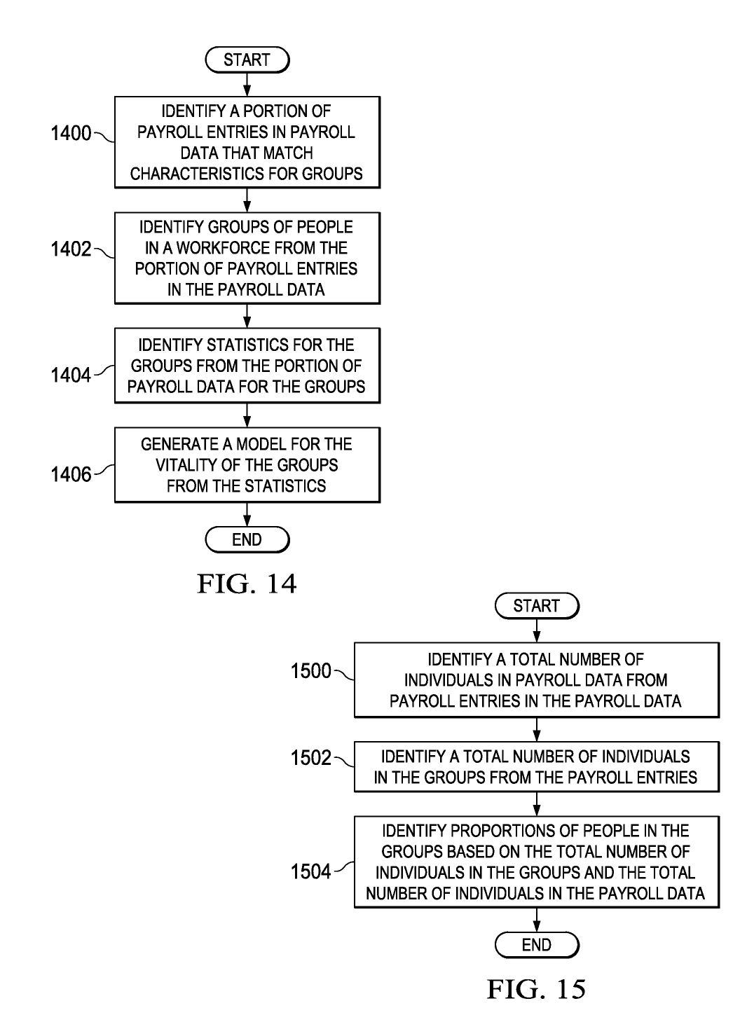

With reference to FIG. 14, an illustration of a flowchart of a process for generating a model for vitality of groups in a workforce is depicted in accordance with an illustrative embodiment. The process illustrated in FIG. 14 may be implemented in workforce management environment 100 in FIG. 1. In particular, the process may be implemented in workforce analyzer 110 in FIG. 1 and FIG. 5. Further, this process may be an example of one implementation of operation 1302 in FIG. 13.

The process begins by identifying a portion of payroll entries in payroll data that match characteristics for groups (operation 1400). The process identifies groups of people in a workforce from the portion of payroll entries in the payroll data (operation 1402).

The process next identifies statistics for the groups from the portion of payroll data for the groups (operation 1404). The process then generates a model for the vitality of the groups from the statistics (operation 1406) with the process terminating thereafter.

In calculating the statistics for the workforce in operation 1404, the process may perform one or more of the following operations: identify the number of job holders for the current period and the previous period; identify the number of job switchers for the current period and the previous period; identify the number of entrants for the current period; identify the number of leavers for the current period; calculate the total employment for the current period from the number of job holders and job switchers for the current period; calculate the total employment for the previous period from the number of job holders and job switchers and leavers for the previous period; calculate the turnover rate for the current period; calculate the average real quarterly wage per employee for job holders and job switchers for the previous period and the current period; calculate the average real quarterly wage per employee for entrants for the current period; identify the number of leavers for the previous period; calculate the average real quarterly wage per employee for leavers for the previous period; calculate the percent of change for quarterly hours worked for job holders and job switchers between the current and previous periods; calculate the percent of change for hourly wage for job holders and job switchers between the current and previous periods; calculate vitality of the workforce for the current period and for the previous period; and calculate the percent of change in vitality of the workforce between the current period and the previous period.

In this example, the process calculates the percent of change in vitality of the workforce between the current period and the previous period using these identified and calculated statistics. For example, the process may calculate the percent of change in vitality of the workforce between the current period and the previous period using the equation:

$$\% Change of WI = \frac{change in WI}{{WI}_{t - 1}} \qquad ( 1 )$$

WI in the equation is vitality of the workforce. Change in WI in the equation is calculated using the following equation:

(Eₜ₋₁)×(1−λ)×Wₜ₋₁^{h}(% charge of quarterly hours worked for job holder+% change of real hourly wage for job holder)+(Eₜ₋₁)×λ×Wₜ₋₁^{s}×(% change of quarterly hours worked for job switcher+% change of real hourly wage for job switcher)+[(Eₜⁿ−Eₜ₋₁^{q})×Wₜⁿ+Eₜ₋₁^{q}×(Wₜⁿ−Wₜ₋₃^{q})] (2)

The variable t is the current period and t−1 is the previous period. A group of equations describing how to calculate portions of equation 2 include:

E^{h}, Eₛ: Number of job holders, switchers; E=E^{h}+E^{s}: Employment excluding entrants and leavers

λ: (Eₜ₋₁^{s}/(Eₜ₋₁^{h}+Eₜ₋₁^{s})) Turnover rate

Wₜ₋₁^{h}, Wₜ₋₁^{s}: Average real quarterly wage per employee for the job holders, switchers

Eₜⁿ: Number of entrants in current period

Wₜⁿ: Average real quarterly wage per employee for the entrants at the current period

Eₜ₋₁^{q}: Number of leavers in the previous period

Wₜ₋₁^{q}: Average real quarterly wage per employee for the leavers in the previous period (3)

With reference next to FIG. 15, an illustration of a flowchart of a process for identifying proportions of groups in payroll data is depicted in accordance with an illustrative embodiment. The process illustrated in FIG. 15 may be implemented in workforce management environment 100 in FIG. 1. In particular, the process may be implemented in workforce analyzer 110 in FIG. 1 and FIG. 6. Further, this process may be an example of one implementation of operation 1304 in FIG. 13.

The process begins by identifying a total number of individuals in payroll data from payroll entries in the payroll data (operation 1500). The process also identifies the total number of individuals in the groups from the payroll entries (operation 1502). The process then identifies proportions of people in the groups based on the total number of individuals in the groups and the total number of individuals in the payroll data (operation 1504) with the process terminating thereafter.

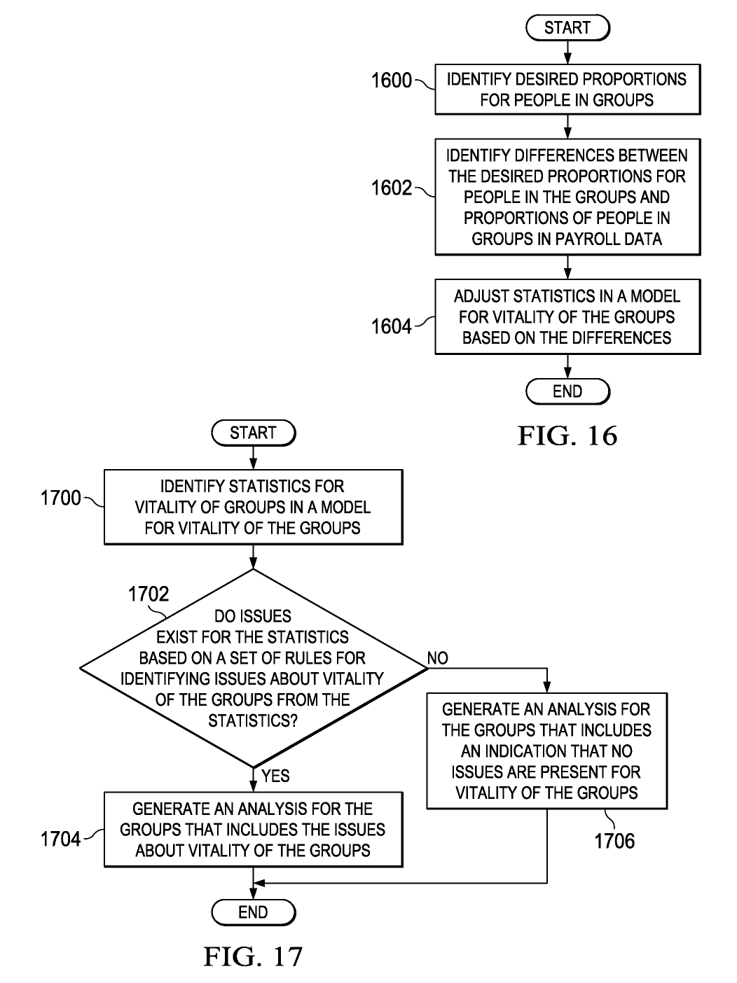

With reference next to FIG. 16, an illustration of a flowchart of a process for adjusting a model for vitality of groups in a workforce is depicted in accordance with an illustrative embodiment. The process illustrated in FIG. 16 may be implemented in workforce management environment 100 in FIG. 1. In particular, the process may be implemented in workforce analyzer 110 in FIG. 1 and FIG. 6. Further, this process may be an example of one implementation of operation 1306 in FIG. 13.

The process begins by identifying desired proportions for people in groups (operation 1600). The process identifies differences between the desired proportions for people in the groups and proportions of people in groups in payroll data (operation 1602). The process then adjusts statistics in a model for vitality of the groups based on the differences (operation 1604) with the process terminating thereafter.

With reference next to FIG. 17, an illustration of a flowchart of a process for performing an analysis is depicted in accordance with an illustrative embodiment. The process illustrated in FIG. 17 may be implemented in workforce management environment 100 in FIG. 1. In particular, the process may be implemented in workforce analyzer 110 in FIG. 1. Further, this process may be an example of one implementation of operation 1310 in FIG. 13.

The process begins by identifying statistics for vitality of groups in a model for vitality of the groups (operation 1700). The process determines whether issues exist for the statistics based on a set of rules for identifying issues about vitality of the groups from the statistics (operation 1702). The set of rules for identifying issues about vitality of the groups from the statistics may include at least one of a rule for selecting the group with the lowest vitality in the groups, a rule for selecting the group with the highest vitality in the groups, a rule for selecting a set of groups that includes the groups with the lowest vitality and the highest vitality, or other suitable rules for identifying issues about vitality of the groups from the statistics.

As depicted, if the issues exist, the process generates an analysis for the groups that includes the issues about vitality of the groups (operation 1704) with the process terminating thereafter. Returning to operation 1702, when the process determines that no issues exist, the process generates an analysis for the groups that includes an indication that no issues are present for vitality of the groups (operation 1706) with the process terminating thereafter.

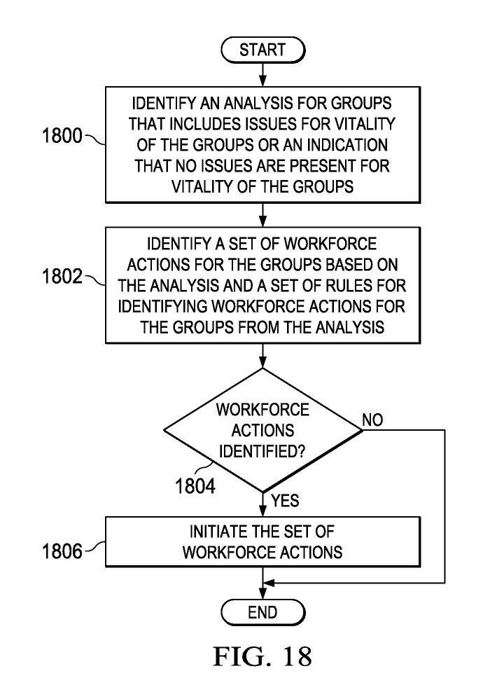

With reference next to FIG. 18, an illustration of a flowchart of a process for identifying and initiating workforce actions is depicted in accordance with an illustrative embodiment. The process illustrated in FIG. 18 may be implemented in workforce management environment 100 in FIG. 1. In particular, the process may be implemented in workforce analyzer 110 in FIG. 1. Further, this process may be an example of one implementation of operation 1312 in FIG. 13.

The process begins by identifying an analysis for groups that includes issues for vitality of the groups or an indication that no issues are present for vitality of the groups (operation 1800). The process identifies a set of workforce actions for the groups based on the analysis and a set of rules for identifying workforce actions for the groups from the analysis (operation 1802). For example, the set of rules for identifying workforce actions may include at least one of a rule for sending messages, a rule for causing changes in characteristics of a group, a rule for scheduling meetings, or other suitable rules for taking workforce actions. For example, a workforce action may be to send a message to personnel to initiate at least one of review of personnel, compensation review, hire new employees, make changes in the work environment, purchase assets, modify organizational structure or other suitable operations for the groups.

The process determines whether workforce actions were identified (operation 1804). As depicted, if the workforce actions were identified, the process then initiates the set of workforce actions with the process terminating thereafter. Returning to operation 1804, when the process determines that no workforce actions were identified, the process terminates without initiating workforce actions.

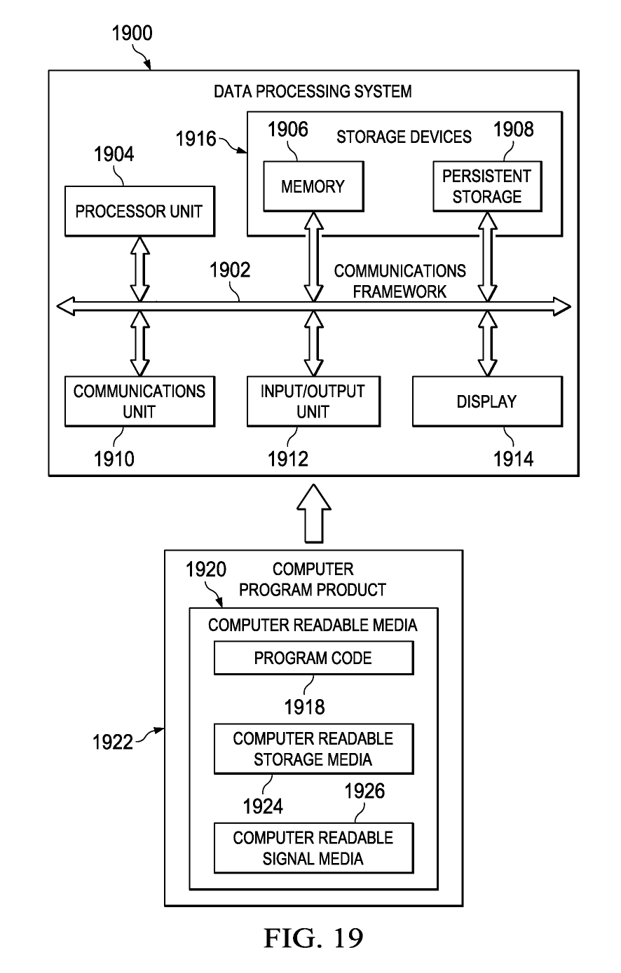

Turning now to FIG. 19, an illustration of a block diagram of a data processing system is depicted in accordance with an illustrative embodiment. Data processing system 1900 may be used to implement one or more computers or other computing or data processing devices in computer system 116 in FIG. 1. In this illustrative example, data processing system 1900 includes communications framework 1902, which provides communications between processor unit 1904, memory 1906, persistent storage 1908, communications unit 1910, input/output (I/O) unit 1912, and display 1914. In this example, communications framework 1902 may take the form of a bus system.

Processor unit 1904 serves to execute instructions for software that may be loaded into memory 1906. Processor unit 1904 may be a number of processors, a multi-processor core, or some other type of processor, depending on the particular implementation.

Memory 1906 and persistent storage 1908 are examples of storage devices 1916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1916 may also be referred to as computer readable storage devices in these illustrative examples. Memory 1906, in these examples, may be, for example, a random access memory or any other suitable volatile or non-volatile storage device. Persistent storage 1908 may take various forms, depending on the particular implementation.

For example, persistent storage 1908 may contain one or more components or devices. For example, persistent storage 1908 may be a hard drive, a flash memory, a rewritable optical disk, a rewritable magnetic tape, or some combination of the above. The media used by persistent storage 1908 also may be removable. For example, a removable hard drive may be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that may be connected to data processing system 1900. For example, input/output unit 1912 may provide a connection for user input through at least one of a keyboard, a mouse, or some other suitable input device. Further, input/output unit 1912 may send output to a printer. Display 1914 provides a mechanism to display information to a user.

Instructions for at least one of the operating system, applications, or programs may be located in storage devices 1916, which are in communication with processor unit 1904 through communications framework 1902. The processes of the different embodiments may be performed by processor unit 1904 using computer-implemented instructions, which may be located in a memory, such as memory 1906.

These instructions are referred to as program code, computer usable program code, or computer readable program code that may be read and executed by a processor in processor unit 1904. The program code in the different embodiments may be embodied on different physical or computer readable storage media, such as memory 1906 or persistent storage 1908.

Program code 1918 is located in a functional form on computer readable media 1920 that is selectively removable and may be loaded onto or transferred to data processing system 1900 for execution by processor unit 1904. Program code 1918 and computer readable media 1920 form computer program product 1922 in these illustrative examples. In one example, computer readable media 1920 may be computer readable storage media 1924 or computer readable signal media 1926.

In these illustrative examples, computer readable storage media 1924 is a physical or tangible storage device used to store program code 1918 rather than a medium that propagates or transmits program code 1918. Alternatively, program code 1918 may be transferred to data processing system 1900 using computer readable signal media 1926. Computer readable signal media 1926 may be, for example, a propagated data signal containing program code 1918. For example, computer readable signal media 1926 may be at least one of an electromagnetic signal, an optical signal, or any other suitable type of signal. These signals may be transmitted over at least one of communications links, such as wireless communications links, optical fiber cables, coaxial cables, wires, or any other suitable types of communications link.

The different components illustrated for data processing system 1900 are not meant to provide architectural limitations to the manner in which different embodiments may be implemented. The different illustrative embodiments may be implemented in a data processing system including components in addition to or in place of those illustrated for data processing system 1900. Other components shown in FIG. 19 can be varied from the illustrative examples shown. The different embodiments may be implemented using any hardware device or system capable of running program code 1918.

The description of the different illustrative embodiments has been presented for purposes of illustration and description, and is not intended to be exhaustive or limited to the embodiments in the form disclosed. Many modifications and variations will be apparent to those of ordinary skill in the art. For example, the different illustrative examples describe components that perform actions or operations. In an illustrative embodiment, a component is configured to perform the action or operation described. For example, the component may have a configuration or design for a structure that provides the component an ability to perform the action or operation that is described in the illustrative examples as being performable by the component.

Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for identifying a vitality for a workforce comprising:
selecting groups of people in the workforce based on a number of characteristics about the groups of people;
generating, by a computer system, a model for the vitality for the groups of people from payroll data for the groups of people, wherein the model shows the vitality for the groups of people as a measure of performance for the groups of people based on the payroll data;
identifying, by the computer system, proportions of the payroll data for the groups of people in the payroll data, wherein the proportions of the payroll data for the groups of people are proportions of sets of the payroll data defined by the number of characteristics about the groups of people; and
adjusting, by the computer system, the model based on a difference between the proportions of the payroll data and desired proportions of the payroll data for the groups of people in the payroll data, wherein the model has a desired level of accuracy and enables changing the workforce based on an analysis using the model.

2. The method of claim 1, wherein the model shows the vitality for the groups as the measure of performance for the groups based on the desired proportions of the payroll data for the groups after adjusting, by the computer system, the model based on the difference.

3. The method of claim 1 further comprising:
generating, by the computer system, the model when at least one of a period of time has passed or a structural change to an economy has occurred that affects the desired level of accuracy.

4. The method of claim 1 further comprising:
generating, by the computer system, a report for the model that shows which of the groups of people in the workforce have a greater need for improvements based on the vitality for the groups of people.

5. The method of claim 1, wherein the payroll data is for groups of employers of different sizes.

6. The method of claim 1, wherein the adjusting step comprises:
identifying ratios between the proportions of the payroll data and the desired proportions of the payroll data as differences.

7. The method of claim 1 further comprising:
removing, by the computer system, any portions of the payroll data failing to pass a set of rules for quality control for the payroll data.

8. The method of claim 1, wherein selecting the groups of people in the workforce comprises receiving, by the computer system, user input that identifies the groups of people.

9. The method of claim 8, wherein the groups of people exclude other groups of people in the workforce, and wherein receiving, by the computer system, the user input that identifies the groups of people is responsive to displaying, by the computer system, the characteristics about the groups of people.

10. A workforce vitality system comprising:
a workforce analyzer that selects groups of people in a workforce based on a number of characteristics about the groups of people; generates a model for vitality for the groups of people from payroll data for the groups of people, wherein the model shows the vitality for the groups of people as a measure of performance for the groups of people based on the payroll data; identifies proportions of the payroll data for the groups of people in the payroll data, wherein the proportions of the payroll data for the groups of people are proportions of sets of the payroll data defined by the number of characteristics about the groups of people; and adjusts the model based on a difference between the proportions of the payroll data and desired proportions for the payroll data for the groups of people in the payroll data, wherein the model for the vitality has a desired level of accuracy and enables changing the workforce based on a result obtained from using the model.

11. The workforce vitality system of claim 10, wherein the model shows the vitality for the groups of people as the measure of performance for the groups of people based on the desired proportions of the payroll data for the groups of people after the workforce analyzer adjusts the model based on the difference.

12. The workforce vitality system of claim 10, wherein the workforce analyzer calculates the model when at least one of a period of time has passed or a structural change to an economy has occurred that affects the desired level of accuracy.

13. The workforce vitality system of claim 10 further comprising:
a workforce analyzer that generates a report for the model that shows which of the groups of people in the workforce have a greater need for improvements based on the vitality for the groups of people.

14. A computer program product for identifying a vitality for a workforce, comprising:
a computer readable storage media;
first program code, stored on the computer readable storage media, for selecting groups of people in the workforce based on a number of characteristics about the groups of people;
second program code, stored on the computer readable storage media, for generating a model for the vitality for the groups of people from payroll data for the groups of people, wherein the model shows the vitality for the groups of people as a measure of performance for the groups of people based on the payroll data;
third program code, stored on the computer readable storage media, for identifying proportions of the payroll data for the groups of people in the payroll data, wherein the proportions of the payroll data for the groups of people are proportions of sets of the payroll data defined by the number of characteristics about the groups of people; and
fourth program code, stored on the computer readable storage media, for adjusting the model based on a difference between the proportions of the payroll data and desired proportions for the payroll data for the groups of people in the payroll data, wherein the model for the vitality has a desired level of accuracy and enables changing the workforce based on a result obtained from using the model.

15. The computer program product of claim 14, wherein the model shows the vitality for the groups of people as the measure of performance for the groups of people based on the desired proportions of the payroll data for the groups after the fourth program code for adjusting the model based on the difference has adjusted the model.

16. The computer program product of claim 14 further comprising:
fifth program code, stored on the computer readable storage media, for generating the model when at least one of a period of time has passed or a structural change to an economy has occurred that affects the desired level of accuracy.

17. The computer program product of claim 14 further comprising:
fifth program code, stored on the computer readable storage media, for generating a report for the model that shows which of the groups of people in the workforce have a greater need for improvements based on the vitality for the groups of people.

18. A method for identifying a workforce vitality comprising:
selecting a group of dimensions for reports about the workforce vitality, wherein the group of dimensions are a number of characteristics about groups of people in a workforce;
calculating, by a computer system, the workforce vitality from payroll data for the groups of people, wherein the payroll data is from a group of employers; and
generating, by the computer system, the reports about the workforce vitality, wherein the reports show the workforce vitality as a measure of performance for the groups of people based on the payroll data, and wherein the reports have a desired level of accuracy that enables selecting which of the groups of people have a greater need for improvements to the workforce vitality for the group of employers.

19. The method of claim 18, wherein in the step of calculating, by the computer system, the workforce vitality comprises:
generating, by the computer system, a model for vitality for the groups from the payroll data, wherein the model shows vitality for the groups as the measure of performance for the groups of people based on the payroll data.

20. The method of claim 19 further comprising:
identifying, by the computer system, proportions of the payroll data for the groups of people in the payroll data, wherein the proportions of the payroll data for the groups of people are proportions of sets of the payroll data defined by the number of characteristics about the groups of people; and
adjusting, by the computer system, the model based on a difference between the proportions of the payroll data and desired proportions of the payroll data for the groups of people in the payroll data.
